(19) United States
(12) Patent Application Publication
(10) Pub. No.: US 2007/0265891 A1
(43) Pub. Date: Nov. 15, 2007

(54) Electronic passenger management method and system in railroad passenger cars/long-distance buses

(76) Inventor: Yixin Guo, Ronkonkoma, NY (US)

Correspondence Address: Yixin Guo, 256 Holbrook Avenue, Ronkonkoma, NY, 11779, US

(21) Appl. No.: 11/430,143

(22) Filed: May 9, 2006

(51) Int. Cl. G06Q 10/00

(52) U.S. Cl. 705/5

(57) ABSTRACT

This present invention is directed to an electronic passenger management system and its corresponding techniques that can be applied to railroad passenger cars/long-distance buses. The system mainly consists of the following parts: an electronic ticket checking machine, a passenger information display device, a passenger management server and database, a computer workstation, and an electronic ticket reader. The computer network connects passenger management server with the electronic ticket checking machine, the passenger information display device, and the computer workstation. This system can be used to check tickets, assign seats, remind passengers of the arrival of destination, display names of destination, change seats, help passengers to purchase tickets on the spot, conduct data enquiries and statistical analyses. This present invention can redress the unsymmetrical status that widely exists between the advanced railroad system/long-distance bus system and the traditional method of requiring conductors to provide manual information to passengers and to replace the old traditional passive passenger information system with the advanced active electronic passenger management system, resulting in further improvement of passenger management and information levels in railroad trains/long-distance buses for their passengers.

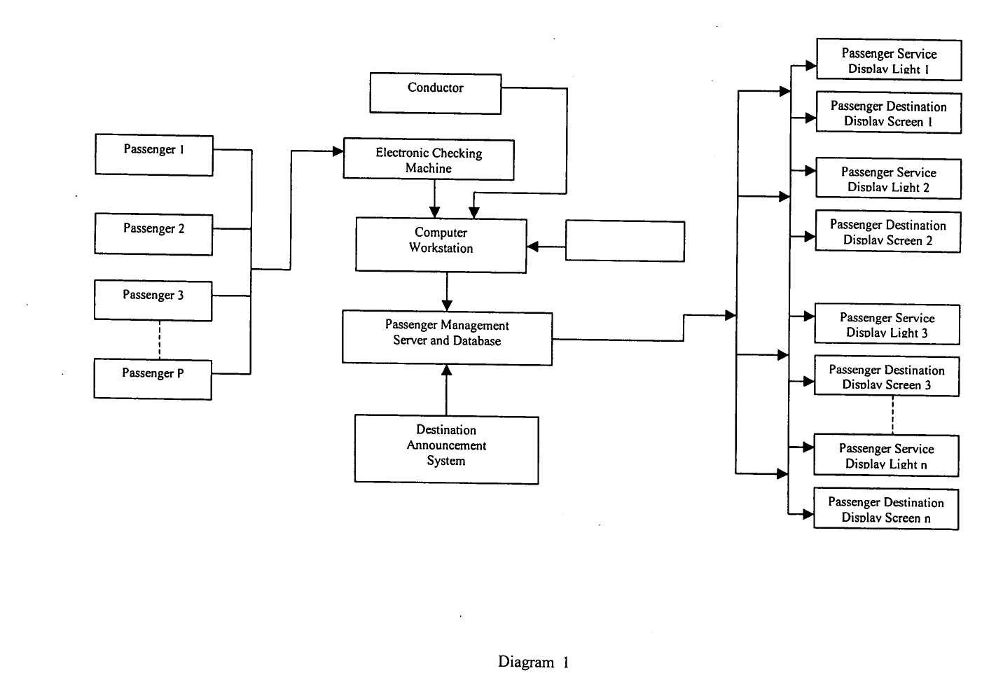

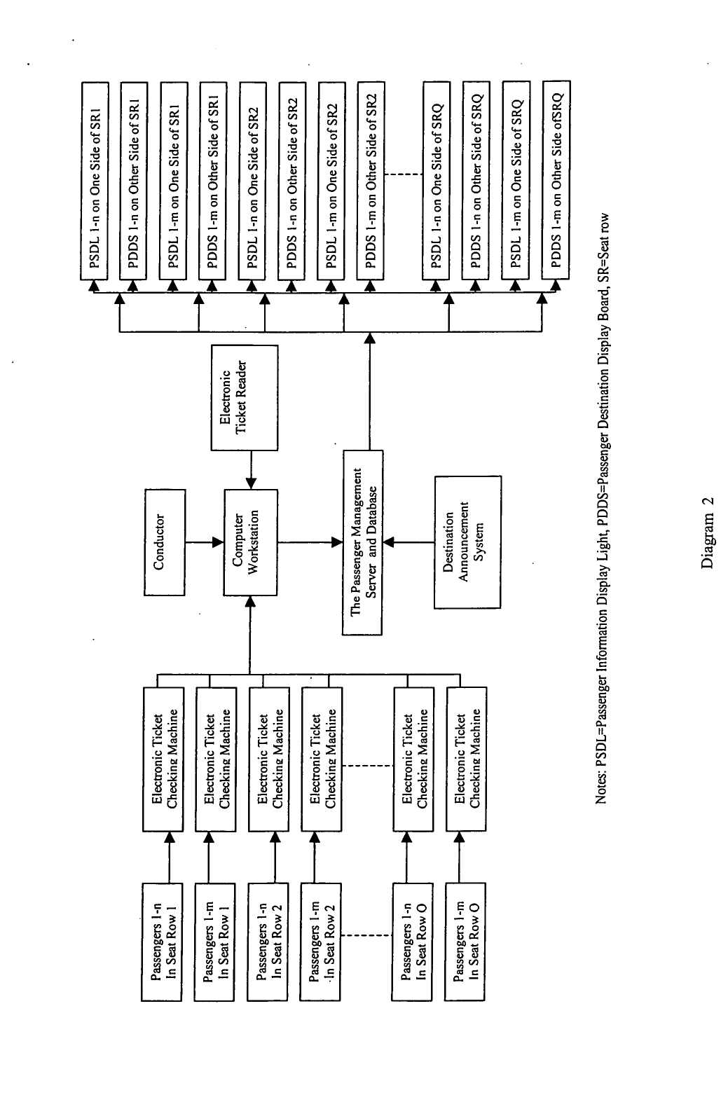

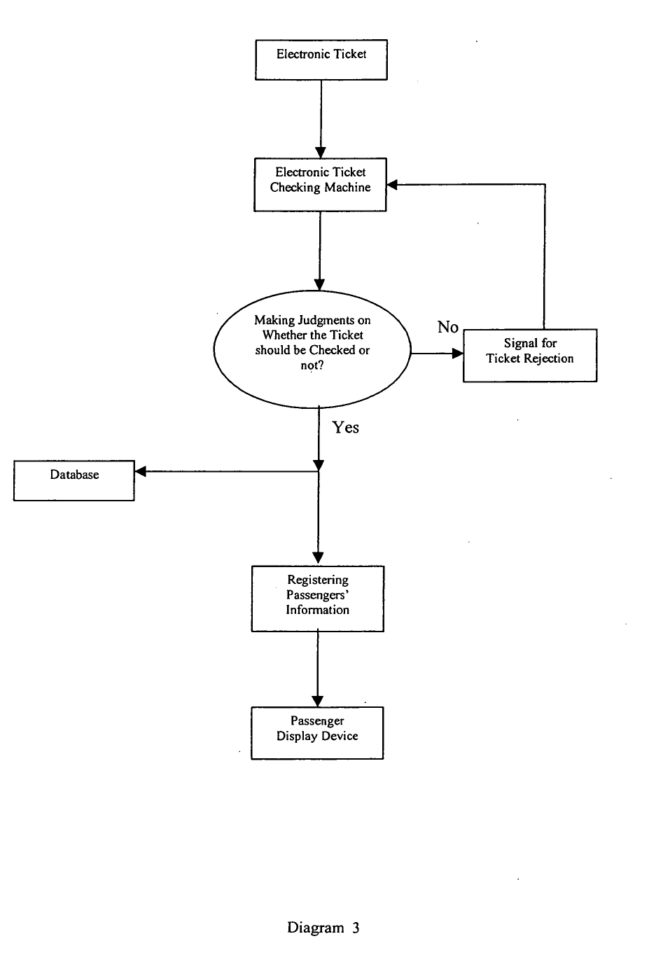

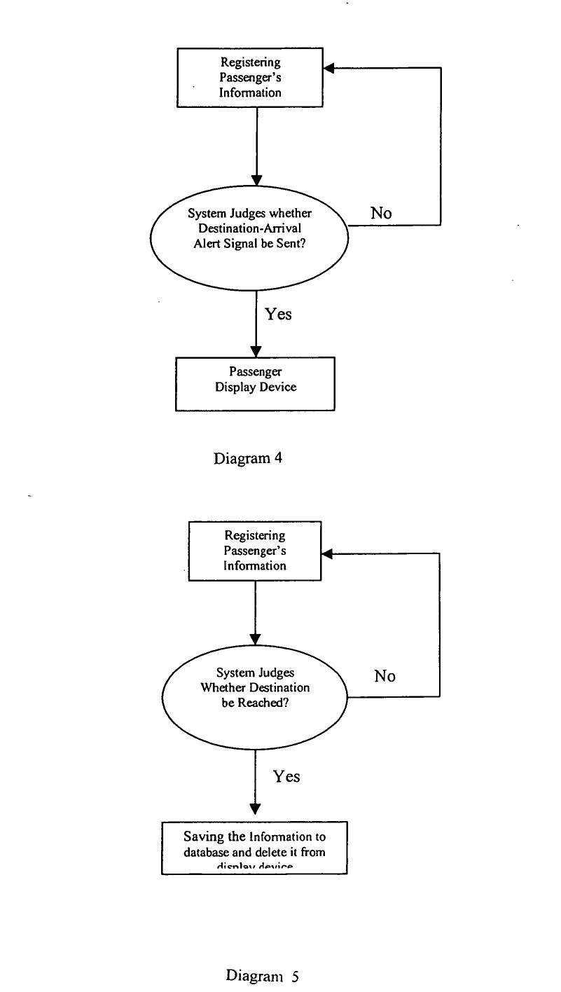

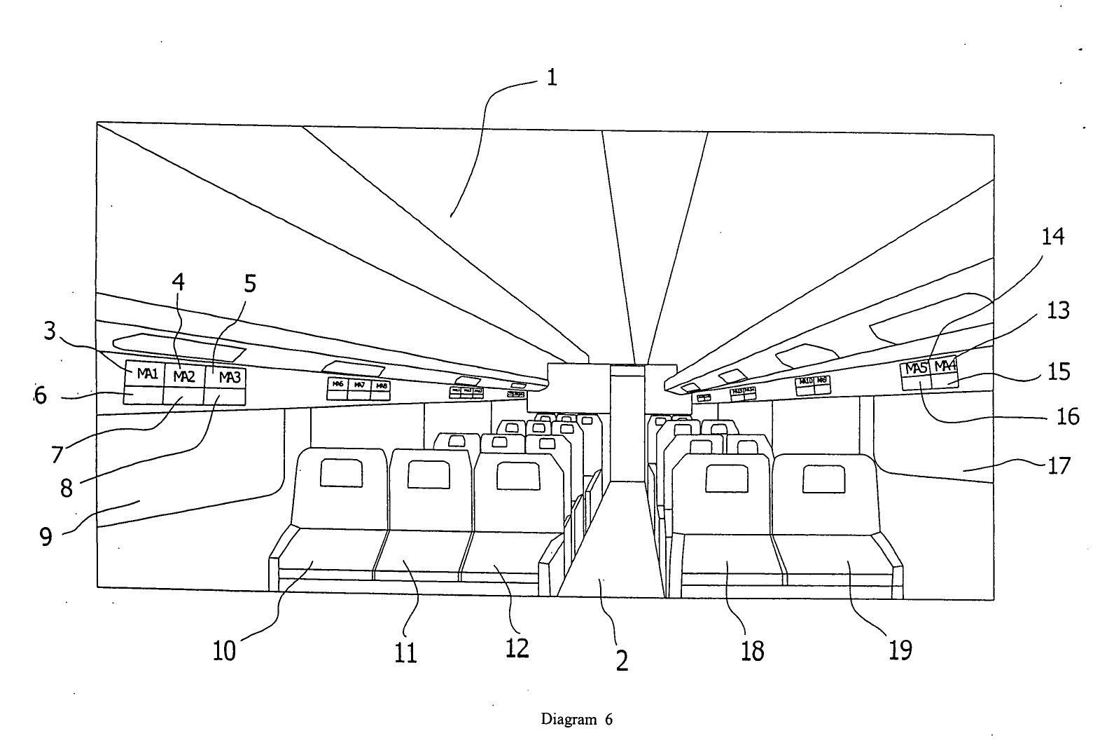

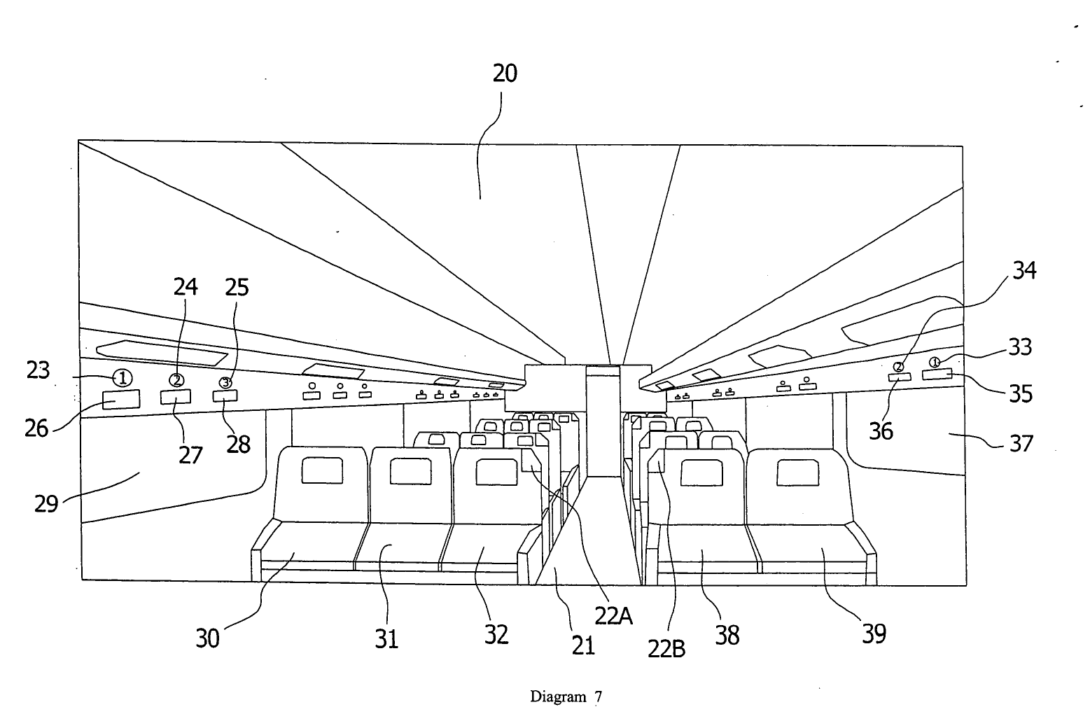

### FIELD OF THE INVENTION

This present invention relates an electronic passenger management system and its corresponding techniques that are applicable to railroad passenger cars/long-distance buses. Particularly this invention pertains to how to provide such information as electronic ticket checking, seat management, destination-arrival alert, and display of destinations on boards for passengers. This invention redresses the unsymmetrical status, that widely exists between the advanced railroad train system/long-distance bus system and the traditional method of requiring conductors to provide manual information to passengers. As a result, the state-of-the-art of modern railroad train system/long-distance bus system can be reflected.

### BACKGROUND OF THE INVENTION

Nowadays, traveling by railroad and long-distance buses becomes an inseparable part of ordinary people's life. Though railroad/long-distance buses provide great conveniences for people to see their friends and relatives, travel for pleasure, make business trips, and commute to and from work, as far as the railroad train system/long-distance bus system in many countries is concerned, conductors provide most information to their passengers, such as ticket-printing and ticket-checking. In addition, passengers have to find their own seats and to make sure themselves that they arrive at their destinations at the right time and at the right place. Under such circumstances, conductors are passive service providers and passengers are passive service receivers, though many railroad passenger cars/long-distance buses are outfitted with top-notch equipments such as soft passenger seats, spacious bath rooms, air-conditioners, special zones for the handicapped, and automatic station arrival announcement, passenger management system is still traditional and backward. This type of passenger management system will no doubt cause disadvantages and even embarrassments to passengers. For example, conductors have to check passengers' tickets several times during the trip; and once re-checking is required, passengers who fall asleep have to be awakened. Since the ticket-checking procedure is time-consuming, some passengers may miss the checking of their tickets if they have to move around in passenger cars, causing miscounting of the number of passengers. In addition, conductors in some railroad passenger cars/long-distance buses leave the punched tickets and/or the punched scraps onto the passenger seats, or onto the floors, or other places, leaving the cars or the buses untidy.

### SUMMARY OF INVENTION

This invention provides electronic passenger management method and system in railroad passenger cars/long-distance buses, the method comprising: an electronic passenger management system and its corresponding techniques that are applicable to railroad passenger cars/long-distance buses. It consists of the following hardware and equipments: Electronic tickets; electronic ticket checking machine; passenger information display device; computer workstation and electronic ticket reader; passenger management server and database; and computer network. This system can be used to check tickets, assign seats, remind passengers of the arrival of destination, display names of destination, change seats, help passengers to purchase tickets on the spot, conduct data enquiries and statistical analyses, and so on. This application serves to redress the unsymmetrical status of quo that widely exists between the advanced railroad system/long-distance bus system and the traditional method of requiring conductors to provide manual information to passengers and to replace the old traditional passive passenger information system with the advanced active electronic passenger management system, resulting in further improvement of passenger management and information levels in railroad trains/long-distance buses for their passengers.

### BRIEF DESCRIPTION OF THE DRAWINGS

Diagram 1 illustrates the flowchart of passenger management system for passenger cars/buses where seats are taken according to the seat numbers shown on the electronic tickets;

Diagram 2 illustrates the flowchart of passenger management system for passenger cars/buses where seats are taken at passengers' own will;

Diagram 3 illustrates the flowchart for checking passengers' electronic tickets;

Diagram 4 illustrates the flowchart for sending destination-arrival alert to passengers;

Diagram 5 is the flowchart for saving the passengers information to database and deleting display device information of the passengers who have left the car/bus.

Diagram 6 illustrates 3-D layout Diagram for the passenger information display light and passenger destination display board in passenger cars/buses where seats are taken according to the seat numbers shown on the tickets;

Diagram 7 illustrates the 3-D layout Diagram for the passenger information display light and passenger destination display board in passenger cars and buses where seats are taken at passengers' own will.

### DETAILED DESCRIPTION OF THE INVENTION

In above Diagrams, Passenger cars/buses 1, where seats are taken according to the seat number shown on the tickets; Walkway 2; The three display lights 3-5 on one side of a seat row in passengers cars/buses where seats are taken according to the seat numbers shown on the ticket; The three destination display boards 6-8 on one side of a seat row in cars and buses where seats are taken according to the number shown on the ticket; The window 9 on one side of the seat row; The three seats 10-12 on one side of the seat row; The two display lights 13, 14 on the other side of a seat row in passenger cars/buses where seats are taken according to the seat numbers shown on the tickets; The two destination display boards 15, 16 on the other side of a seat row in passenger cars/buses where seats are taken according to the seat numbers shown on the tickets; The window 17 on the other side of the Seat row; The two seats 18, 19 on the other side of the Seat row; Passenger cars/buses 20 where seats are taken at passengers' own will; Walkway 21; Electronic ticket checking machine 22A and 22B in passenger cars or buses where seats are taken at passengers' own will; The three display lights 23-25 on one side of a seat row in passenger cars and buses where seats are taken at passengers' own will; The three destination display boards 26-28 on one side of a seat row in passenger cars/buses where seats are taken at passengers' own will; The window 29 on one side of the Seat row; The three seats 30-32 on one side of the Seat row; The two display lights 33, 34 on the other side of a seat row in passenger cars/buses where seats are taken at passengers' own will; The two destination display boards 35, 36 on the other side of a seat row in passenger cars/buses where seats are taken at passengers' own will; The window 37 on the other side of the Seat row; The two seats 38, 39 on the other side of the Seat row.

The present invention provides an advanced electronic passenger management system and its corresponding techniques that can be used to check tickets, assign seats, remind passengers of their destinations and display destinations on boards. The purpose of this system is to replace the old traditional passive passenger management system with the advanced active electronic passenger management system, so as to improve passenger management level in railroad trains/long-distance buses and redress the unsymmetrical status that railroad passenger cars/long-distance buses are equipped with modern technology while passenger management mode therein is lagging far behind.

The system consists of the following hardware and equipments:
(1). Electronic tickets;
(2). Electronic ticket checking machine;
(3). Passenger information display device;
(4). Computer workstation and electronic ticket reader;
(5). Passenger management server and database;
(6). Computer network.

Specifically, as proof of purchase for riding in passenger cars and buses, an electronic ticket is subject to several forms such as electron-magnetic sweep form, IC information sweep form, or infrared scan form, and contains at least the following information:
A. Departing place and destination;
B. Date, time, and shift of passenger cars/long-distance buses;
C. Price of the ticket;
D. Time of purchase and expiry time.

Electronic ticket checking machines are compatible with electronic tickets, and their number and location should be based according to the following two arrangements:
A. In cars/buses where seats are taken according to the seat number shown on the tickets, electronic ticket checking machine should be installed by the entrance and exit of the cars/buses;
B. In cars/buses where seats are taken at passengers' own will, electronic ticket checking machine should be installed on each seat row by the walkway.

Passenger information display device is supposed to be installed on the wall above window on each side of a row of seats. Every seat is supposed to have a displace device that corresponds to its passenger. As part of the passenger management system, the workstation and the electronic ticket reader are installed where the conductor is working.

The management system server is connected to the electronic ticket checking machine, passenger information display device, and the computer workstation through computer network, thus forming the so-called electronic passenger management system.

Specific contents of the above technical scenario are described as follows:
1. The electronic ticket can also be printed with written information like that on an ordinary paper ticket. As a result, on one hand, the passenger can read what is contained in the electronic ticket, and on the other hand, the passenger can avoid taking a train/bus that does not have an electronic ticket checking machine or other equipments that are parts of the electronic passenger management system.
2. The passenger information display device includes at least a display light; it can also include a destination display board.
3. The electronic ticket checking machine is structured to process electromagnetic insert card, electromagnetic sweep card, IC contact card, IC radio-frequency card, and infrared scan card.
4. Information recorded in the electronic ticket can also include types of tickets, such as single-trip ticket, round-trip ticket, daily ticket, weekly ticket, monthly ticket, senior ticket, child ticket, and other related information.
5. The electronic ticket reader is an accessory part to the computer workstation. When passengers change their seats, purchase tickets on the train/bus, etc, the conductor needs to process the electronic tickets using the ticket reader.

In order to achieve the above purposes, this invention adopts a technical design that can be applied to railroad passenger cars/long-distance buses. The following contents are included in the technical design:
(1). Electronic ticket checking machine, passenger information display device, management system server, workstation, and electronic ticket reader are installed in railroads passenger cars/long-distance buses. The computer network connects management system server with electronic ticket checking machine, passenger information display device, and the computer workstation. In terms of the installation of the electronic ticket checking machine in passenger cars/buses, the following two choices can be made:
A. In passenger cars/buses where seats are taken according to the seat number on the ticket, electronic ticket checking machine should be installed by the entrance and exit of the cars/buses;
B. In passenger cars/buses where seats are taken at passengers' own will, electronic ticket checking machine should be installed on each seat row by the walkway.

Passenger information display device should be installed corresponding to each seat on the wall above window on each side of the seat row in the passenger car/bus.

Each seat has a passenger information display device, the display data depends electronic ticket information. Each passenger car/bus should be equipped with the computer workstation and the electronic ticket reader where conductor can operating.
(2). In terms of each seat and its corresponding passenger information display device, before a passenger gets on the passenger car/bus, the display device should indicate that the status of the seat is vacant. When passengers aboard the passenger car/bus produce their electronic tickets for checking by the electronic ticket checking machine, information in the electronic ticket is processed and transmitted to the management system for final decision. If information in the electronic ticket does not match that stored in the system, a rejection signal is produced. If information in the electronic ticket matches that in the system, an acceptance signal is produced. Then information of the checked tickets is recorded in the electronic ticket and stored in the database. Meanwhile, the database will establish the passenger's register information for the seat. The passenger's register information will then be sent to the passenger information display device installed above the passenger's seat, indicating that the passenger has boarded the passenger car/bus, ready to take the seat. While the train/bus is in motion, the destination of the passenger is monitored automatically. Before the passenger's destination is reached, an alert signal will be sent to the passenger information display device reminding the passenger to get ready for getting off the passenger car/bus. When the destination is reached, the passenger's information will be Saved to database and deleted from display device, and a vacancy signal will be sent to the display device that corresponds to the empty seat. If this seat is taken by a new passenger, the process will be repeated until the final destination is reached.
(3). The conductor can access the computer workstation and the ticket reader with user name and password to help passengers change seats, purchase on-the-spot tickets, and deal with other situations, including making changes or storing new information in the database. In addition, distribution maps for passenger seats can also be displayed in the workstation.
(4). By accessing the management system with user name and password, the conductor can enquire about or calculate the number of passengers riding in the passenger car/bus from the departing place to the destination for each shift. The conductor can also access such information as trip routes, ticket revenues, and other recorded data.
(5). The database in the above electronic passenger management system can be connected wirelessly to the central passenger management system in the railroad terminal/long-distance bus terminal. As a result, the number of passengers in passenger cars/buses that are in motion becomes immediately available, making it possible to exercise an all-out control over each passenger car/bus in a broader sense.

Relevant details of what is mentioned above will be explained as follows:
1. The passenger information display device includes a display light. When the light is off, it indicates that the seat is vacant; and when the light is on, it indicates that the seat is taken by a passenger. When the light is flashing, it indicates an alert signal for destination arrival. In addition, the display device also includes a board for displaying the name of the destination in written characters. The time for displaying the destination name is arranged by making one of the following two choices:
A. The destination of the passenger is displayed the moment the ticket of the passenger is checked, and the display continues until the train/bus reaches the destination.
B. After the passenger's ticket is checked, the display of the destination starts for a while and then stops. Before the train/bus reaches the destination for a while, the display resumes and continues until the destination is reached.
2. In passenger cars/buses where seats are taken according to seat numbers shown on the tickets. When a passenger produces his/her electronic ticket for checking, the passenger management system not only judges whether the date, time, and the shift in the electronic ticket matches those in the system, it also judges whether the passenger car/bus's seat number and shift match those in the system. In addition, the system also judges whether the seat for the passenger is vacant or not. Only when the date, seat number, time, and the shift in both the electronic ticket and in the system match, will the system accept the checking of the ticket. Otherwise, the electronic ticket is rejected.

In passenger cars/buses where seats are taken at passengers' own will, when a passenger produces his/her electronic ticket for checking in the seat row electronic ticket checking machine, the passenger management system judges whether the date, time, and the shift in the electronic ticket matches those in the system, in addition, the system also judges whether the seat row for the passenger has vacant seats, only when the date, time, and the shift in both the electronic ticket and in the system match or the time of the ticket has not expired, and the seat row for the passenger has vacant seats, will the system accept the checking of the ticket. Otherwise, the electronic ticket is rejected.
3. In passenger cars/buses where seats are taken at passenger's own will, the passenger information display device displays only the ordinal number on each side of the seat row, like 1-n and 1-m, where m and n are numbers of seats on each side of the seat row. The ordinal number, which has nothing to do with seat number, is displayed on the passenger information display device when the ticket of a passenger is checked. Since seats can be taken at will, the passenger can take a seat anywhere in the row of seats. But the passenger should remember the ordinal number because the display device that corresponds to the seat row will display the name of the passenger's destination and send a destination-arrival alert signal.
4. In passenger cars/buses where seats are taken according to the seat numbers shown on the electronic tickets, passengers should have their electronic tickets checked at the entrance/exit of the designated passenger car/bus; otherwise, the system will reject the ticket and displays the number of the right car/bus.

The present invention will have the following advantages over the traditional techniques used in current passenger cars/buses:
1. This invention provides railroad passenger cars/long-distance buses with an advanced electronic passenger management system that can be used to check tickets, assign seats, remind passengers of their destinations and display destinations on boards. This invention redresses the unsymmetrical status, that passenger cars and buses are equipped with modern technology while passenger management mode therein is lagging far behind. The purpose of the invention is to replace the old traditional passive passenger information system with the advanced active electronic passenger management system, so as to improve passenger management and information levels in railroad trains/long-distance buses.
2. This invention helps to quicken the steps for passengers to take their seats, eliminating possible disadvantages caused by manual ticket checking procedure. For example, in traditional manual checking, conductors have to check passengers' tickets several times during the trip; and once re-checking is required, passengers who fall asleep have to be awakened.
3. This invention serves to eliminate the possibility that conductors in some railroad passenger cars/long-distance buses leave the punched tickets and/or the punched scraps onto the passenger seats, or onto the floors, or other places, making the cars/buses untidy. By applying this invention, the cleanliness of the passenger cars/buses outfitted with advanced technology and equipments can be ensured.
4. This invention helps to improve the modernization of the layout of railroad passenger cars/long-distance buses.
5. This invention helps to advance the development of technologies through which electronic passenger management system for railroad passenger cars/long-distance buses can be connected wirelessly to the central passenger control system in the railroad terminal/long-distance bus terminal. As a result, the number of passengers in passenger cars/buses that are in motion becomes immediately available, making it possible to exercise an all-out control over each passenger car/bus.

### SAMPLES

### Example 1

What is illustrated in Diagram 1 and Diagrams 3-6 is an electronic passenger management system and its corresponding techniques that can be applied to in railroad passenger cars/long-distance buses where seats are taken according to the numbers shown on the tickets purchased. Specifically, this system, which consists of an electronic ticket checking machine, a passenger information display device, a management system server, a computer workstation, and an electronic ticket reader, is installed in the railroad train or the bus. Supported by the database and the management software, the management system is connected via computer network with the electronic ticket checking machine, the passenger information display device, and the computer workstation. Specifically, the electronic ticket checking machine is installed at the entrance/exit of passenger car/bus. For railroad passenger cars, the ticket checking machine can be installed at the two entrances/exits of each car. The display device can be installed corresponding to each seat on the wall above window on each side of the seat row in the passenger car/bus, and consists of the passenger information display light and the display board for showing the names of destination, which is illustrated in Diagram 6. on the left side of a seat row are the three display lights (3-5) and the three destination display boards (6-8). On the right side of a Seat row are two display lights (13 and 14) and two destination display boards (15 and 16). Information in the locations of each passenger information display light and of each destination display board stored in the electronic passenger management system matches that in the location where the information of the targeted passenger is registered.

That is:

Passenger information display light 3 and passenger destination display board 6→Seat 10;

Passenger information display light 4 and passenger destination display board 7→Seat 11;

Passenger information display light 5 and passenger destination display board 8→Seat 12;

Passenger information display light 13 and passenger destination display board 15→Seat 18;

Passenger information display light 14 and passenger destination display board 16→Seat 19.

The numbers of the above passenger destination display board match their corresponding seat numbers. That is:

Passenger destination display board 6 and seat 10 are MA1;

Passenger destination display board 7 and seat 11 are MA2;

Passenger destination display board 8 and seat 12 are MA3;

Passenger destination display board 15 and seat 18 are MA4;

Passenger destination display board 16 and seat 19 are MA5.

Every passenger car/bus is equipped with a workstation and an electronic ticket reader, both of which are installed where the conductor is working.

The electronic ticket is the proof of purchase for riding in the passenger car/bus, and is recorded with the following information:
A. Departing place and destination;
B. Time, date, and shift of the passenger train/bus;
C. Price of the ticket;
D. Time of purchase and expiry time;
E. The number of the railroad passenger car/bus and the seat number;
F. Type of tickets, such as single-trip ticket, round-trip ticket, daily ticket, weekly ticket, monthly ticket, senior ticket, or child ticket;
G. Other related information.

The electronic ticket checking machine is structured to process electromagnetic insert card, electromagnetic sweep card, IC contact card, IC radio-frequency card, and infrared scan card.

As illustrated in Diagram 6, above the three passenger information display lights (3-5) on the left side are three seat numbers—MA1, MA2, MA3, indicating the three seats on the left side of Seat row A in Car M. Specifically, MA1 represents Seat 10, MA2 Seat 11, and MA3 Seat 12. Above the two passenger information display lights (13 and 14) on the right side are seat numbers MA4 and MA5, indicating the two seats on the right side of Seat row A in Car M. Specifically, MA4 represents Seat 18 and MA5 Seat 19 (Seat number can also be marked by the side of the display light).

As illustrated in Diagram 3, suppose that three passengers get ready to board railroad passenger Car M in the departing place, and their seat numbers are MA1, MA2, and MA3 respectively on Seat row A. Before the passengers board the passenger car, all the passenger information display lights and all the passenger destination display board are off, indicating that all the three seats are vacant. When the three passengers aboard produce their electronic tickets for checking at the entrance/exit of Car A, the electronic ticket checking machine reads information recorded in the tickets and then, based on information retrieved from the passenger management system, determines that the date, time, shift, and the number of passenger cars/buses in the electronic tickets match those in the system. In addition, the actual seats that match the seat numbers on the tickets are also found to be vacant. Consequently the system accepts the checking of the electronic tickets by producing acceptance signal, and the information of the checked tickets is then recorded in the electronic tickets (Otherwise, the electronic tickets are rejected, and subsequent information is shown). Then relevant information is stored in the database while the register system in the database establishes passenger information for each of the three passengers. Finally, based on the information of the three passengers who have boarded the passenger car/bus, the passenger management system sends signals to passenger information display lights 3, 4, and 13, thus turning on MA1, MA2, and MA4, indicating that passengers for Seats 10, 11, and 18 respectively are ready to take their seats. Meanwhile, passenger destination display boards 6, 7, and 15 begin to display the respective destination names for the three passengers. For example:

| | | |
|---|---|---|
| MA1 | Destination Name | S1 |
| MA2 | Destination Name | S2 |
| MA4 | Destination Name | S4 |

The time for displaying destination names is arranged by making one of the following two choices:
A. The destination of the passenger is displayed the moment the ticket of the passenger is checked, and the display continues until the passenger train/bus reaches the destination.
B. After the passenger's ticket is checked, the display of the destination starts for a while and then stops. Sometime before the passenger train/bus reaches the destination, the display resumes and continues until the destination is reached.

As illustrated in Diagram 4, while the train or the bus is in motion, passengers' destination can be monitored automatically (The time of arrival for the destination can be provided by the original destination report system in the railroad passenger cars/long-distance buses, or it can be produced automatically by the data management system).

Suppose destination S1 is the first destination. Minutes before S1 is reached, destination-arrival alert signal is sent to MA1 (The alert signal is expressed by a flashing light), reminding passenger MA1 to get ready for getting off. As demonstrated in Diagram 5, when destination S1 is reached, the passenger information for Seat 10 is saved to database, the passenger display device information for Seat 10 will be deleted while passenger information display light 3 and passenger destination display board 6 are turned off, the Seat 10 is vacant now. If a new passenger MA1 boards the passenger car/bus at destination S1 whose destination is Sn, then the process is repeated until the final destination is reached.

While the passenger train/bus is in motion, for the sake of passengers' convenience, the conductor can access the workstation and the ticket reader with user name and password to help passengers change seats, purchase on-the-spot tickets, and deal with other situations, including making changes or storing new information in the database. By accessing the management system with user name and password, the conductor can also enquire about or calculate the number of passengers riding in the passenger car/bus from the departing place to the destination for each shift. The conductor can also access such information as trip routes, ticket revenues, and other recorded data. In addition, the database in the electronic passenger management system and techniques for railroad passenger cars/long-distance buses can be connected wirelessly to the central passenger control system in the railroad terminal/the long-distance bus terminal. As a result, the number of passengers in passenger cars/buses that are in motion becomes immediately available, making it possible to exercise an all-out control over each passenger car/bus in a broader sense. For the sake of efficiency, high-performance management system should be installed on railroad cars, and small-sized system to long-distance buses.

### Example 2

What is illustrated in Diagram 2, Diagrams 3-5, and Diagram 7 is an electronic passenger management system and its corresponding techniques that can be applied to railroad passenger cars/long-distance buses where seats are taken at passengers' own will. Specifically, this system, which consists of an electronic ticket checking machine, a passenger information display device, a management system, a computer workstation, and an electronic ticket reader, is installed in the railroad passenger car/bus. The management system is connected via computer network with the electronic ticket checking machine, passenger information display device, and the computer workstation. Specifically, the electronic ticket checking machine is installed on the top/side of the Seat rows on each side of the walkway in Passenger Car 20, like the electronic ticket checking machines 22A and 22B in Diagram 7. The passenger information display device, which consists of the passenger information display light and the board for displaying names of destination, as is illustrated in Diagram 7, can be installed corresponding to each seat on the wall above window on each side of the Seat row in the passenger car/bus. In Car 20, on the left side of a seat row are the three display lights (23-25) and the three destination display boards (26-28). On the right side of the Seat row are two display lights (33 and 34) and two destination display boards (35 and 36).

In passenger cars/buses where seats are taken at passenger's own will, the passenger information display device displays only the ordinal number on each side. Specifically, one side ordinal number is 1-n, where n is the seat number on one side of the seat row, as seats 30, 31, and 32, in Diagram 7, where n=3. The ordinal number on the other side is 1-m, where m is the seat number of the other side, like seats 38 and 39 in the same Diagram, where m=2. The ordinal number, which has nothing to do with seat number, is displayed on the passenger information display device when the ticket of a passenger is checked. Since seats can be taken at will, the passenger can take a seat anywhere in the row of seats. But the passenger should remember his/her ordinal number because the display device that corresponds to his/her ordinal number will display the name of the destination and sends an alert signal to remind the passenger that his/her destination is reached.

Information in the locations of each passenger information display light and of each destination display board stored in the electronic passenger management system match that in the location where the information of the targeted passenger is registered. That is:

Passenger information display light 23 and passenger destination display board 26;

Passenger information display light 24 and passenger destination display board 27;

Passenger information display light 25 and passenger destination display board 28.

The above pairs have Seats 30, 31, and 32.

Passenger information display light 33 and passenger destination display board 35;

Passenger information display light 34 and passenger destination display board 36.

The above pairs have Seats 38 and 39.

Every passenger car/bus is equipped with a workstation and an electronic ticket reader, both of which are installed where the conductor is working.

The electronic ticket serves as proof of purchase for riding in the passenger car/bus, and is recorded with the following information:
A. Departing place and destination;
B. Time, date, and shift of the passenger train/bus;
C. Price of the ticket;
D. Time of purchase and expiry time;
E. Types of tickets, such as single-trip ticket, round-trip ticket, daily ticket, weekly ticket, monthly ticket, yearly ticket, senior ticket, or child ticket;
F. Other related information.

The electronic ticket checking machine can be structured to process electromagnetic insert card, electromagnetic sweep card, IC contact card, IC radio-frequency card, and infrared scan card.

As illustrated in Diagram 7, the three passenger information display lights (23-25) on the left side indicate Seats 30, 31, and 32 on the left side of a seat row, while the two passenger information display lights (33 and 34) on the right side indicate Seats 38 and 39.

As illustrated in Diagram 3, suppose that in the departing place, four passengers get ready to board a railroad passenger car. Before the passengers board the passenger car, all the passenger information display lights and all the passenger destination display board are off, indicating that all the seats are vacant. When three of the passengers aboard produce their electronic tickets for checking in Passenger Car 20, the electronic ticket checking machine 22A reads information recorded in the tickets and then, based on information retrieved from the passenger management system, makes judgments. The conditions for the system to check an electronic ticket are: (1) the ticket's time, date, and shift in both the ticket checking machine and the system match, (2) the time of the ticket has not expired (the ticket may be a round-trip ticket, daily ticket, weekly ticket, and monthly ticket), and (3) the electronic ticket has not been checked before and the seat indicated in the ticket is vacant. In this case, the system accepts the checking of the electronic tickets by producing acceptance signal, and the information of the checked tickets is recorded in the electronic tickets (Otherwise, the electronic ticket is rejected, and subsequent information is shown). Then relevant information is stored in the database while the register system in the database establishes passenger information for each of the three passengers. Finally, based on the information of the three passengers who have boarded the car, the passenger management system sends signals to passenger information display lights 23, 24, and 25, indicating that Passengers 1, 2, and 3 are ready to take their respective seats—Seats 30, 31, and 32. Meanwhile, passenger destination display boards 26, 27, and 28 begin to display the respective destination names for the three passengers, like:

| | | | |
|---|---|---|---|
| Ordinal number 1 | Passenger 1 | Destination Name | S1 |
| Ordinal number 2 | Passenger 2 | Destination Name | S2 |
| Ordinal number 3 | Passenger 3 | Destination Name | S3 |

The time for displaying destination names is arranged by making one of the following two choices:
A. The destination of the passenger is displayed the moment the ticket of the passenger is checked, and the display continues until the train or the bus reaches the destination.
B. After the passenger's ticket is checked, the display of the destination starts for a while and then stops. Sometime before the passenger train/bus reaches the destination, the display resumes and continues until the destination is reached.

When the fourth passenger aboard produce his/her electronic ticket for checking in Car 20, the electronic ticket checking machine 22B reads information recorded in the ticket and then, like what has already been described above, makes judgments. If 22B finds that Seats 38 and 39 are vacant, the system will send a signal based on this passenger's information to indicate that the passenger is aboard, which turns on passenger information display light 33 for the ordinal number 1. Meanwhile, the passenger destination display board 35 shows the name of the destination for the passenger, like:
Ordinal number 1 Passenger 4 Destination Name S2
   indicating that Passengers 4 and 2 will get off at the same destination.

What should be paid special attention to here is that in passenger cars/buses where seats are taken at passengers' own will, the system will produce a ordinal number for the passenger according to a predetermined order, and the ordinal number is shown in the passenger's display device.

Suppose there are m seats on the right side of a seat row. When a passenger checks his/her ticket through the electronic ticket checking machine, the system will produce a predetermined seat row ranging from 1 to m. The ordinal number is not a seat number. The passenger can take any seat in the seat row, but should remember the ordinal number, because the display device that corresponds to the ordinal number will display information about his/her destination and sends a destination-arrival alert signal.

As illustrated in Diagram 4, while the train or the bus is in motion, the four passengers' destinations can be monitored automatically (The time of arrival at these destinations can be provided by the original destination report system in the railroad train/long-distance bus, or it can be produced automatically by the data management system).

Suppose destination S1 is the first destination. Minutes before S1 is reached, destination-arrival alert signal is sent to passenger information display light 23 (The alert signal is expressed by a flashing light), reminding Passenger 1 to get ready for getting off. As demonstrated in Diagram 5, when destination S1 is reached, the passenger information in display device for Seat 30 is deleted while passenger information display light 23 and passenger destination display board 26 are turned off, now that Seat 30 is vacant. If a new passenger, whose destination is Sn, boards the passenger car/bus at destination S1, then the process is repeated until the final destination is reached.

While the train or the bus is in motion, for the sake of passengers' convenience, the conductor can access the computer workstation and the ticket reader with user name and password to help passengers change seats and purchase on-the-spot tickets, and to deal with other situations, including making changes or storing new information in the database. By accessing the management software with user name and password, the conductor can also enquire about or calculate the number of passengers riding in the passenger car/bus from the departing place to the destination for each shift. The conductor can also access such information as trip routes, ticket revenues, and other recorded data. In addition, the database in the electronic passenger management system and techniques for railroad passenger cars/long-distance buses can be connected wirelessly to the central passenger control system in the railroad terminal/long-distance bus terminal. As a result, the number of passengers in passenger cars/buses that are in motion becomes immediately available, making it possible to exercise an all-out control over each passenger car/bus in a broader sense. For the sake of efficiency, high-performance management system should be installed on railroad passenger cars, and small-sized processor to long-distance buses.

1. A method comprising: an electronic passenger management system and its corresponding techniques that are applicable to railroad passenger cars/long-distance buses. It consists of the following hardware and equipments:
(1). Electronic tickets;
(2). Electronic ticket checking machine;
(3). Passenger information display device;
(4). Computer workstation and electronic ticket reader;
(5). Passenger management server and database;
(6). Computer network.
The electronic ticket checking machines are subject to several forms such as electron-magnetic sweep form, IC information sweep form, or infrared scan form, and contains at least the following information:
A. Departing place and destination;
B. Date, time, and shift of passenger cars/long-distance buses;
C. Price of the ticket;
D. Time of purchase and expiry time.
Electronic ticket checking machines are compatible with electronic tickets, and their number and location should be based according to the following two arrangements:
A. In cars/buses where seats are taken according to the seat number shown on the tickets, electronic ticket checking machine should be installed by the entrance/exit of the each cars/bus;
B. In cars/buses where seats are taken at passengers' own will, electronic ticket checking machine should be installed on each seat row by the walkway.
As a showcase board for displaying the status of seats and passenger-related information, passenger information display device is supposed to be installed on the wall above window on each side of a row of seats. Every seat is supposed to have a displace device that corresponds to its passenger.
As part of the passenger management system, the computer workstation and the electronic ticket reader are installed where the conductor is working.
The passenger management system server is connected to the electronic ticket checking machine, passenger information display device, and the computer workstation through computer network.

2. The method of claim 1, further comprising: the passenger information display device includes at least a display light.

3. The method of claim 1, further comprising: the passenger information display device includes at least a passenger destination display board.

4. The method of claim 1, further comprising: the said electronic ticket checking machine is structured to process electromagnetic insert card, electromagnetic sweep card, IC contact card, IC radio-frequency card, and infrared scan card.

5. The method of claim 1, further comprising:
(1). Electronic ticket checking machine, passenger information display device, the passenger management system, the workstation, and electronic ticket reader are installed in railroads passenger cars/long-distance buses, supported by the management system in the train or bus. The computer network connects passenger management system with electronic ticket checking machine, passenger information display device, and the computer workstation. In terms of the installation of the electronic ticket checking machine in passenger cars/buses, the following two choices can be made:
A. In passenger cars/buses where seats are taken according to the seat number on the ticket, electronic ticket checking machine should be installed by the entrance and exit of the cars/buses;
B. In passenger cars/buses where seats are taken at passengers' own will, electronic ticket checking machine should be installed on each seat row by the walkway.
Passenger information display device should be installed corresponding to each seat on the wall above window on each side of the seat row in the passenger car/bus. Each passenger car/bus should be equipped with the workstation and the electronic ticket reader, both of which should be installed where the conductor is working.
(2). In terms of each seat and its corresponding passenger information display device, before a passenger gets on the passenger car/bus, the display device should indicate that the status of the seat is vacant. When passengers aboard the passenger car/bus produce their electronic tickets for checking by the electronic ticket checking machine, information in the electronic ticket is processed and transmitted to the system for final decision. If information in the electronic ticket does not match the data that stored in the system, a rejection signal is produced. If information in the electronic ticket matches the data that stored in the system, an acceptance signal is produced. Then information of the checked tickets is recorded in the electronic ticket and stored in the database. Meanwhile, the register system in the database will establish the passenger's information for the seat. The passenger's information will then be sent to the passenger information display device installed above the passenger's seat, indicating that the passenger has boarded the passenger car/bus, ready to take the seat. While the train/bus is in motion, the destination of the passenger is monitored automatically. Before the passenger's destination is reached, an alert signal will be sent to the passenger information display device reminding the passenger to get ready for getting off the passenger car/bus. When the destination is reached, the passenger's information will be saved and the seat information is empty, a vacancy signal will be sent to the display device that corresponds to the empty seat. If this seat is taken by a new passenger, the process will be repeated until the final destination is reached.
(3). The conductor can access the workstation and the ticket reader with user name and password to help passengers change seats, purchase on-the-spot tickets, and deal with other situations, including making changes or storing new information in the database. In addition, distribution maps for passenger seats can also be displayed in the workstation.
(4). By accessing the management system with user name and password, the conductor can enquire about or calculate the number of passengers riding in the passenger car/bus from the departing place to the destination for each shift. The conductor can also access such information as trip routes, ticket revenues, and other recorded data.

6. The method of claim 5, further comprising: The electronic passenger management system for railroad passenger cars/long-distance buses can be connected wirelessly to the central passenger control system in the railroad terminal/long-distance bus terminal. As a result, the number of passengers in passenger cars/buses that are in motion becomes immediately available, making it possible to exercise an all-out control over each passenger car/bus.

7. The method of claim 5, further comprising: the passenger information display device includes a display light. When the light is off, it indicates that the seat is vacant; and when the light is on, it indicates that the seat is taken by a passenger. When the light is flashing, it indicates an alert signal for destination arrival.

8. The method of claim 7, further comprising: the display device also includes a board for displaying the name of the destination in written characters. The time for displaying the destination name is arranged by making one of the following two choices:
A. The destination of the passenger is displayed the moment the ticket of the passenger is checked, and the display continues until the train/bus reaches the destination.
B. After the passenger's ticket is checked, the display of the destination starts for a while and then stops. And before the train/bus reaches the destination for a while, the display resumes and continues until the destination is reached.

9. The method of claim 5, further comprising: In passenger cars/buses where seats are taken according to seat numbers shown on the tickets. When a passenger produces his/her electronic ticket for checking, the passenger management system not only judges whether the date, time, and the shift in the electronic ticket matches those in the system, it also judges whether the passenger car/bus's number and shift match those in the system. In addition, the system also judges whether the seat for the passenger is vacant or not. Only when the date, time, and the shift in both the electronic ticket and in the system match, will the system accept the checking of the ticket. Otherwise, the electronic ticket is rejected.
In passenger cars/buses where seats are taken at passengers' own will, when a passenger produces his/her electronic ticket for checking in the seat row electronic ticket checking machine, the passenger management system judges whether the date, time, and the shift in the electronic ticket matches those in the system, in addition, the system also judges whether the seat row for the passenger has vacant seats, only when the date, time, and the shift in both the electronic ticket and in the system match or the time of the ticket has not expired, and the seat row for the passenger has vacant seats, will the system accept the checking of the ticket. Otherwise, the electronic ticket is rejected.

10. The method of claim 9, further comprising: In passenger cars/buses where seats are taken at passenger's own will, the passenger information display device displays only the ordinal number on each side of the seat row, like 1-n and 1-m, where m and n are numbers of seats on each side of the seat row. The ordinal number, which has nothing to do with seat number, is displayed on the passenger information display device when the ticket of a passenger is checked. The passenger can take a seat anywhere in the row of seats. But the passenger should remember the ordinal number because the display device that corresponds to the seat row will display the name of the passenger's destination and send a destination-arrival alert signal to remind the passenger that his/her destination is reached.
